(19) United States
(12) Patent Application Publication
(10) Pub. No.: US 2004/0041472 A1
(43) Pub. Date: Mar. 4, 2004

(54) Energy storage for DC power supply

(75) Inventors: Johni Chan, Rancho Santa Fe, CA (US); Guy Thrap, Del Mar, CA (US)

Correspondence Address: FITCH EVEN TABIN AND FLANNERY, 120 SOUTH LA SALLE STREET, SUITE 1600, CHICAGO, IL, 60603-3406, US

(73) Assignee: I-BUS Corporation, San Diego, CA (US)

(21) Appl. No.: 10/233,278

(22) Filed: Aug. 29, 2002

(51) Int. Cl. H02J 7/00

(52) U.S. Cl. 307/64

(57) ABSTRACT

The present invention provides an apparatus and method for on-board ride-through power during power glitches including a power storage device being configured to store power from a supply voltage without disrupting power supplied to a load and the power storage device being further configured to supply power to the load when the supply voltage drops below a voltage across the power storage device. The power storage device can include one or more capacitors. The present invention receives a supply voltage and determines if the supply voltage exceeds a reference voltage while allowing normal operation of a load. The invention further stores power from the supply voltage if the supply voltage exceeds the reference voltage, and supplies power to the load if the supply voltage drops.

### BACKGROUND OF THE INVENTION

1. Field of the Invention

The present invention relates generally to electric power supplies, and more specifically to providing short-term energy storage to maintain the DC output voltage of a power supply during power failures.

2. Discussion of the Related Art

The loss of power for even a few microseconds in the operation of computers, computing systems and other analog and digital systems and networks can disrupt normal operation with potentially disastrous results. Often the loss of power requires computers or systems to reboot or restart. This reboot often results in the loss of data and greatly reduces the efficiency of operation of the computer or system. Large output capacitors of hundreds of microfarads are sometimes coupled with systems to provide transient ride through times of a few milliseconds. Many systems employ a large and external uninterruptible power supply to continue to provide power during line voltage interruptions. However, these external power sources are typically expensive and in some instances fail to react quickly enough.

### SUMMARY OF THE INVENTION

The present invention advantageously addresses the needs above as well as other needs by providing an apparatus and method for providing ride-through and/or alternate power during power glitches. In one embodiment, the invention can be characterized as an apparatus for providing ride-through power, comprising a power storage device being configured to store power from a supply voltage without disrupting power supplied to a load; and the power storage device being further configured to supply power to the load when the supply voltage drops, wherein the power storage device is configured to supply power to the load when the supply voltage drops below a voltage across the power storage device and the power storage device includes a first capacitor.

In another embodiment, the invention can be characterized as an apparatus for providing on-board ride-through power for a circuit board, having a load configured to receive a supply voltage; and an on-board ride-through compensator, comprising a power storage device being coupled with the load, and the power storage device being configured to store power from the supply voltage without disrupting power supplied to the load and to supply power to the load when the supply voltage drops.

In another embodiment, the invention can be characterized as an apparatus for providing ride-through, where the ride-through apparatus includes a comparator having a first input being configured to receive a first voltage, a second input being configured to receive a second voltage, and a comparator output, wherein the comparator asserts the comparator output when the first voltage is at least equal to the second voltage; a switch coupled with the comparator output, wherein the switch is in a first state when the comparator output is asserted and in a second state when the comparator output is not asserted; a power storage device being coupled with the switch, wherein the power storage device is configured to store power from the first voltage when the switch is in the first state; and the power storage device being further configured to supply power if a drop in the first voltage occurs.

In another embodiment, the invention can be characterized as a method for providing power compensation. The method for providing power compensation comprising the steps of receiving a supply voltage; determining if the supply voltage exceeds a reference voltage; allowing operation of a load; storing power from the supply voltage if the supply voltage exceeds the reference voltage; and supplying power to the load if the supply voltage drops.

In another embodiment, the invention can be characterized as a circuit board, comprising: a load configured to receive a supply voltage; and means for supplying power, comprising means for storing power coupled with the load, and the means for storing power stores power from the supply voltage without disrupting power supplied to the load and to supply power to the load when the supply voltage drops.

A better understanding of the features and advantages of the present invention will be obtained by reference to the following detailed description of the invention and accompanying drawings that set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 depicts a simplified block diagram of a ride-through apparatus according to one embodiment of the present invention;

FIG. 2 depicts a simplified schematic diagram of one embodiment of the ride-through apparatus; and

FIG. 3 shows a flow diagram of a process for providing power ride-through according to one embodiment of the present invention.

Corresponding reference characters indicate corresponding components throughout the several views of the drawings.

### DETAILED DESCRIPTION OF THE INVENTION

The following description is not to be taken in a limiting sense, but is made merely for the purpose of describing the general principles of the invention. The scope of the invention should be determined with reference to the claims.

The present invention is capable of supplying current to the load during power outages, power sags and/or power glitches. Further, the present apparatus can be constructed directly on a circuit board or microchip, such as on a single board computer. As such, the present invention avoids the need for a separate external ride-through device to compensate for power glitches, and thus provide rapid response avoiding reboots and restarts.

Previous systems must reboot when a power glitch or power interruption occurs. Some systems have attempted to go off the circuit board to receive ride-through power during a power interrupt or glitch. Going off the board requires an excess amount of time to activate the alternate power and to receive the alternate power. This excess amount of time often results in loss of data and or processing. Typically these previous systems still require a system reboot because the alternate power cannot supply power quickly enough.

The present method and apparatus provides on-board alternate power to avoid having to go off board or off chip to receive the alternate power to ride-through temporary power outages and glitches. Thus, boards or chips implementing the present invention avoid the need to have to reboot by receiving alternate power quickly and from an on-board alternate power supply.

Many previous systems employ large and expensive, external uninterruptible power supplies to continue to provide power during line voltage interruptions. However, this is costly and adds additional components, sometimes completely separate components, and adds complexity.

The present invention alternatively takes advantage of the advent of small printed circuit mount capacitors with values into the tens of farads to provide a power ride through with sufficient time extending to several hundred milliseconds or longer. However, directly connecting a ten-farad capacitor across the output of a regulated DC power supply prevents the supply from starting up properly. Most circuit boards, computers and other systems require the power supplies to ramp up to an operating voltage in less than hundreds of milliseconds and often less than one hundred milliseconds.

The present apparatus provides, in one embodiment, a circuit that charges a power storage device, which can include one or more large value output capacitors, without disrupting the normal power supply operation to the load. The present invention can be implemented directly in a circuit board to provide rapid on-board power compensation. For example, the present invention can be implemented directly into a single board computer to compensate for power glitches and interrupts.

In one embodiment, the present apparatus and method provides one or more energy storage devices, such as one or more capacitors or large value capacitors, in series with one or more switching devices, such as field effect transistors. The switching device is controlled by a voltage comparator that compares a voltage provided by a power supply to a precision reference voltage. When the power supply is initially powered up, the present apparatus and method allows the power supply to ramp up to a predefined minimum operating voltage (e.g., 4.75V for a 5V power supply). Once the power supply voltage reaches the minimum operating voltage, the comparator drives the switching device to a conduction state.

In the conduction state, the switching device forms a shunt regulator across the power supply. This has the effect of consuming the excess capability of the power supply to charge up the energy storage device. For example, if the power supply current limits at ten amps and the applied load is six amps, then the remaining four amps from the power supply are used to charge the energy storage device. After the energy storage device is charged, the power supply or source voltage continues to ramp up to a normal regulation level. The power supply at the normal regulation level drives the voltage comparator output to turn the switching device on to its maximum conduction state. Once the energy or power storage device is charged the present ride-through apparatus and method supplies the load current to the power supply during power glitches.

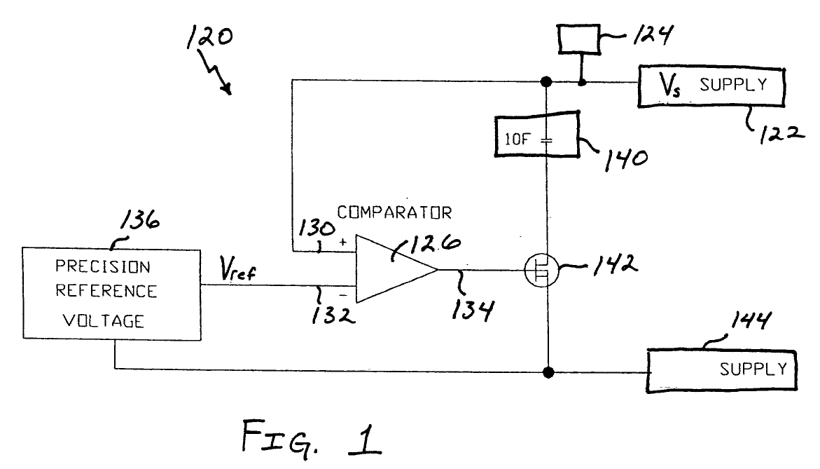

FIG. 1 depicts a simplified block diagram of a ride-through apparatus 120 according to one embodiment of the present invention. The apparatus 120 includes a power supply 122 that supplies power to one or more loads 124. Upon activating or turning on the power supply 122, the voltage Vₛ across the power supply begins to ramp up towards a predefined operational voltage. For example, the power supply 122 can supply an operational voltage of 5 V for circuit board operation. As another example, the power supply can supply an operational voltage of 3.3 V for low threshold transistor circuit board operation.

The power supply 122 couples with a first input 130 of a comparator 126. A second input 132 of the comparator couples with a reference voltage source 136. The reference voltage source supplies a reference voltage V_{ref} to the second input 132. A ride-through power storage device 140, such as one or more capacitors or other power storage devices, couples between the power supply 122 and a switch 142. In one embodiment, the switch 142 is implemented through one or more transistors, such as field effect transistors, bi-polar junction transistors or substantially any other type or combination of transistors. An output 134 of the comparator 126 additionally couples with the switch 142.

As the supply or source voltage Vₛ supplied by the power supply 122 ramps up, the voltage at the first terminal 130 is compared by the comparator 126 with the reference voltage V_{ref} at the second terminal 132. Once the supply voltage Vₛ equals and/or exceeds the reference voltage V_{ref}, the comparator asserts the output 134. For example, the assertion of the output can be a transition from a high state to a low state or from a low state to a high state. The assertion of the output 134 activates the switch into conduction mode to close the path from the power supply 122 to a low reference 144, such as ground. The closed path allows current to flow charging up the ride-through power storage device 140.

As the ride-through storage device charges up, the supply voltage Vₛ is maintained at a voltage substantially equal with the reference voltage (or slightly greater than the reference voltage depending on the comparator implemented). The ride-through storage device 140 continues to charge up until the voltage level across the storage device is equal to the supply voltage Vₛ (minus any voltage drop across the switch 142).

In one embodiment, the comparator 126 in cooperation with the switch 142 charge the ride-through storage device 140 at a pre-selected constant current rate. The constant current rate can be defined by the level of the comparator output 134 driving the switch, or through the switch pulling all the excess power from the power source 122. When the voltage across the power storage device equals the supply voltage Vₛ the voltage from the voltage source 122 continues to rise to the predefined operational voltage pulling the first input 130 of the comparator greater than the reference voltage at the second input 132. The comparator 126 continues to assert the output 134 maintains the switch 142 in a conduction state, which continues to allow current to flow through the ride-through storage device 140 charging the storage device. In one embodiment, the switch is implemented through a semiconductor switch. When the supply voltage is at the operational voltage, the comparator output drives the semiconductor switch to its lowest on impedance.

Typically the reference voltage V_{ref} is defined at a voltage level sufficiently high to allow accurate operation of the load 124. For example, the reference voltage V_{ref} can be set to approximately 4.75 V or higher, which is a typical minimum operating voltage to allow accurate operation of typical integrated circuits or circuit board components. As another example, the reference voltage can be set to approximately 3.1 V or higher, which is a minimum voltage for accurate operation of some alternative integrated circuits. As such, the charging of the storage device 140 does not interfere with the power supply 122 quickly reaching a voltage level to accurately operate the load. Thus, the power supply can provide power to the load within the system requirements (e.g., in under hundreds of milliseconds or under one hundred milliseconds depending on the system requirements) and the charging of the storage device 140 does not limit or adversely affect the operation of the load 124.

Once the voltage source 122 reaches an operation voltage, the comparator continues to assert the output 134 to drive the switch 142 to charge the ride-through storage device 140, maintaining the ride-through storage device 140 at substantially the operational supply voltage.

If the voltage source 122 should fail, a power interruption should occur with the power source or some other reason the supply voltage drops, the ride-through storage device 140 begins to discharge supplying power to the load 124. The ride-through storage device continues to supply power to the load until the power failure is no longer present and the voltage source 122 ramps back to a voltage level equal to or greater than the reference voltage V_{ref}, or until the voltage V_{psd} across the ride-through storage device 140 falls below the reference voltage (and thus the minimum voltage at which the load accurately operates).

This causes the comparator 126 to de-asset the comparator output 134 and shut off the switch 142. In one embodiment, the ride-through power storage device 140 couples with the load through a low impedance discharge path to support the load current during power glitches or interruptions.

Once the power interrupt or failure is no longer present and the voltage source ramps back up to a level equal with the reference voltage V_{ref}, the comparator 130 asserts the switch 142 to again charge the ride-through power storage device 140 back to approximately the desired operational supply voltage as the source continues to rise to the operational supply voltage.

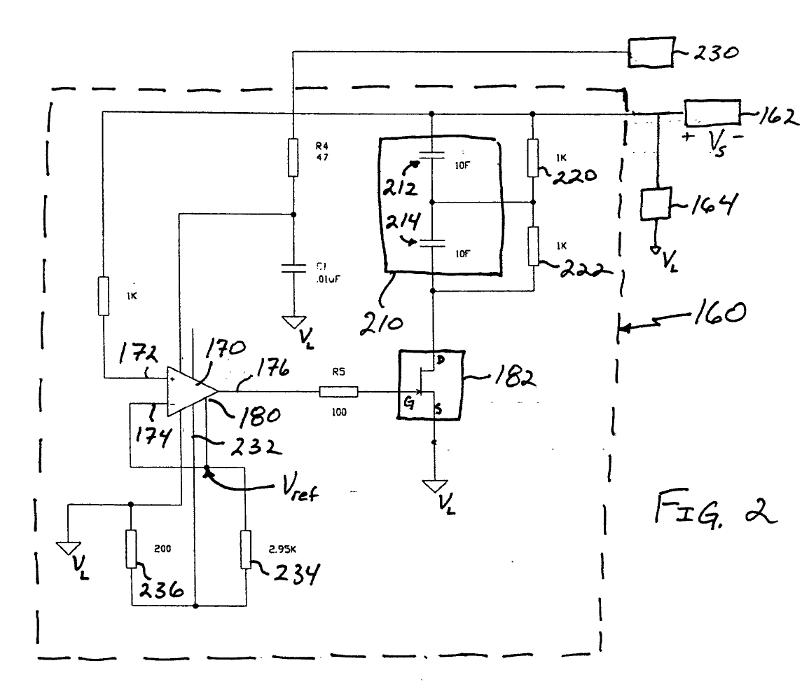

FIG. 2 depicts a simplified schematic diagram of one implementation of a ride-through apparatus 160 according to one embodiment of the present invention. The apparatus 160 couples with a power supply 162. The power supply further couples with and supplies power to a load 164. The load can be substantially any electronic component, including one or more transistors, microprocessors and other components. Typically, the load 164 and apparatus 160 are formed on a single chip or board.

The power supply 162 couples with a positive input 172 of a comparator 170. The comparator can be implemented through substantially any device capable of comparing, such as, but not limited to, an operation amplifier. An inverting input 174 of the comparator couples with a reference voltage V_{ref}. In one embodiment, the comparator 170 includes a reference voltage output 180 that generates the reference voltage V_{ref}, which is forwarded to the inverting input 174.

In one embodiment, the reference voltage V_{ref} is alternatively generated external to the comparator. The comparator output 176 couples with a switch 182. In one embodiment, the switch 182 is implemented through a semiconductor switch or one or more transistors, where the transistor(s) can be a FET, MOSFET and substantially any other transistor or combination of transistors know in the art.

A ride-through power storage device 210, such as a ride-through capacitance, additionally couples with the power supply 162. In one embodiment, the ride-through storage device is implemented through a first capacitor 212 and a second capacitor 214 coupled in series. In one embodiment, the first and second capacitors 212, 214 are high energy ultra capacitors formed directly in the board or chip. For example, the first and second capacitors can both be double layer 10F capacitors capable of holding approximately 2.5 V each. However, other capacitance configurations, such as three or four series capacitors or a single capacitor, can be utilized without departing from the scope of the invention. In a preferred embodiment, the first and second capacitors 212, 214 are formed directly on the same chip or board along with the ride-through apparatus 160.

In one embodiment, a first balancing resistor 220 couples across the first capacitor 212 and a second balancing resistor 222 couples across the second capacitor 214. A first terminal of the first capacitor 212 couples with the voltage source 162 and the second terminal of the first capacitor 212 couples with a first terminal of the second capacitor 214. A second terminal of the second capacitor couples with the switch 210. As an example, the switch can be implemented through a FET transistor where the second terminal of the second capacitor couples with a drain D of the switch transistor 182. The gate G of the switch transistor 182 couples with the comparator output 176. The source S of the switch transistor 182 couples with a low reference voltage V_{L}.

In operation, as the power supply 162 is activated and begins to ramp up to a desired operating voltage, the comparator 170 compares the supply voltage Vₛ with the reference voltage V_{ref}. Once the supply voltage reaches a voltage level greater than the reference voltage, the comparator asserts the output 176. The asserted output activates the switch transistor 182 to begin conducting current.

Once the switch transistor 182 begins to conduct current, the first and second capacitors 212, 214 begin to charge up. As a result, the switch transistor pulls excess energy or power from the power supply 162 that is not utilized by the load or other system components, causing the ride-through power storage device 210 to charge up. The switch transistor maintains the supply voltage Vₛ at a steady or constant voltage level that is equal to or slightly greater than that of the reference voltage V_{ref} until the ride-through storage device 210 is charged to a voltage level substantially equal to the supply voltage Vₛ.

Once the ride-through storage device 210 has a voltage equal to the supply voltage, the supply voltage VS then continues to ramp up to the desired operating or regulation voltage level. As the supply voltage ramps up, the ride-through power storage device also ramps up until the ride-through storage device has a voltage substantially equal to that of the supply voltage at the operating voltage.

If the supply voltage Vₛ drops due to a power glitch, such as a power interrupt, power sag or other power disruption, the ride-through storage device 210 discharges to maintain a substantially constant power level to the load(s) 164. The ride-through storage device 210 maintains a very stable voltage across the load 164 during power glitches. As such, the load does not experience the power glitch or power sag. The storage device 210 continues to supply power to the load until the power supply 162 ramps back up and the supply voltage Vs exceeds the voltage level across the ride-through storage device 210, or until the voltage across the load supplied by the ride-through power storage device falls below the reference voltage V_{ref}.

In one embodiment, the comparator 170 is powered by the power source 162 or a second power source 230. For example, the comparator 170 can be powered or driven by a 12 V power supply 230, such as a 12 V power supply typically found in computers. As another example, when lower gate threshold devices are utilized, such as a lower gate threshold switch, the comparator 170 can be driven by a lower power supply voltage (e.g., 5 V). The comparator 170 can additionally include a reference voltage feedback 232. In one implementation, the reference voltage feedback couples between a first reference voltage resistor 234 and a second reference voltage resistor 236. The first and second reference voltage resistors aid in establishing the voltage level of the reference voltage V_{ref} supplied by the comparator reference voltage output 180. As one example, if the power source 162 is configured to supply a voltage level of 3.3 V, the minimum operating voltage is typically 3.1 V. As such, the desired reference voltage V_{ref} is set to a level of at least 3.1 V. The first reference voltage resistor 234 is set to 2.95KΩ and the second reference voltage resistor is set to 200 Ω, establishing a feedback voltage to maintain the reference voltage V_{ref} at a stable level.

As another example, if the power supply 162 provides a supply voltage Vₛ of 5 V, then a typical minimum operating voltage is approximately 4.75 V. Thus, the reference voltage is set to a level equal to or greater than 4.75 V. To achieve a desired reference voltage feedback, the first reference voltage resistor can have a resistance of 4.55 KΩ and the second reference voltage resistor can have a resistance of 200 Ω. It will be apparent to one skilled in the art that other combinations of resistances and/or other resistance values can be used to establish an accurate reference voltage feedback without departing from the scope of the present invention.

In one embodiment, the ride-through power storage device 210 is implemented utilizing first and second high energy ultra capacitors coupled in series. For example, two 10F ultra capacitors can be utilized to supply a load current at a sufficient level to drive the load for up to 200 milliseconds depending on the load, and typically 300 milliseconds or more depending on the load demand. Circuit boards and chips experience power glitches that are typically a few milliseconds or less. Thus, the present ride-through apparatus 120, 160 is capable of compensating for at least 90% of most power glitches, and usually at least 95% of most power glitches. Most power transients are less than a 10-30 microsecond domain. For example, if lightning hits, a power interruption of a few milliseconds might occur, or if the power company supplying power to the power source 162 is performing a switch at a power station, a power interruption of around 2 to 3 milliseconds might occur. The present ride-through apparatus is capable of providing hundreds of milliseconds of power for ride-through, thus the ride-through apparatus is capable of compensating for most power glitches and/or sags.

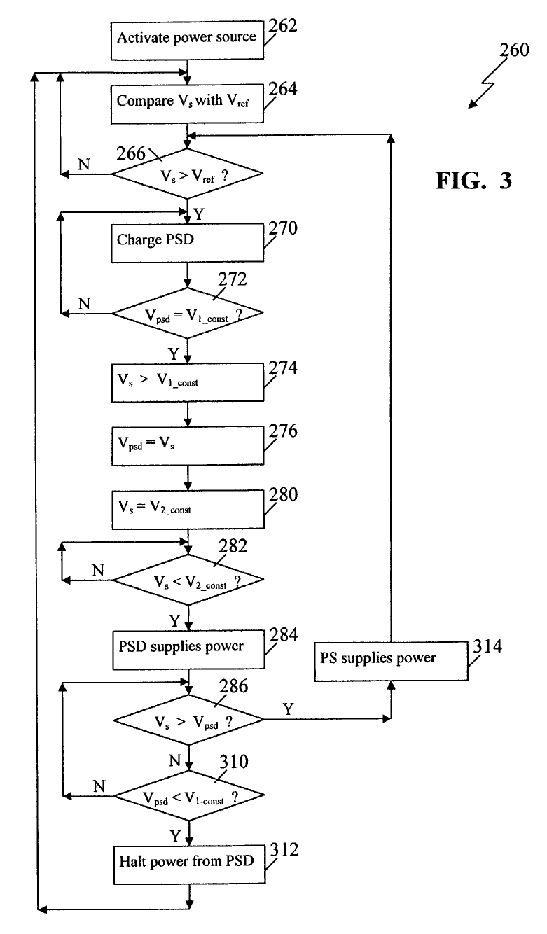

FIG. 3 shows a flow diagram of a process 260 for providing on-board power ride-through for a circuit board or chip. In step 262, a power source is activated to provide a supply voltage Vₛ. In step 264, the voltage level of supply voltage is compared with a reference voltage V_{ref}. In step 266, it is determined whether the supply voltage is greater than the reference voltage. If the supply voltage is not greater, the process returns to step 264 to continue comparing the supply voltage with the reference voltage.

If, in step 266, the supply voltage Vₛ does exceed the reference voltage V_{ref}, the process 260 transitions to step 270 where power is supplied by the power source to a load, power is pulled from the power source to charge a power storage device (PSD), and the voltage level of the power source is maintained at a first substantially constant value (V₁_{_{—}}_{const}). In step 272, it is determined if the power stored by the power storage device results in a voltage level (V_{psd}) equal to the first constant value. If the power stored by the power storage device is not sufficient to provide a voltage level equal with the first constant value, the process returns to step 270. If the power level of the power storage device is sufficient to provide a voltage equal with the first constant value, step 274 is entered where the voltage of the power source increases above the first constant value.

In step 276, the power stored by the power storage device additionally increases as the voltage of the power source increases. In step 280, the voltage of the power source is maintained at a second substantially constant value (V₂_{_{—}}_{const}) and the power stored by the power storage device is maintained at a first constant power level. In step 282 it is determined if the supply voltage Vₛ drops below the second constant value. If the supply voltage does not drop, the process returns to step 282 to continue to monitor the supply voltage supplied to the load. If it is determined in step 282 that the supply voltage Vₛ dropped, step 284 is entered where the power storage device discharges to supply power to the load maintaining a stable voltage to the load.

In step 286, it is determined whether the voltage level of the power source (Vₛ) exceeds a voltage supplied to the load by the power storage device (V_{psd}). If it is determined that the voltage level of the power source does not exceed the voltage supplied to the load by the power storage device, the process proceeds to step 310 where it is determined whether the voltage V_{psd} supplied by the power storage device is less than the first constant value. If the voltage supplied by the power storage device is less than the first constant value, step 312 is entered where the power supplied by the power storage device is halted and the process 260 returns to step 264. If, in step 310, the power supplied by the power storage device provides a voltage V_{psd} to the load that is greater than the first constant value, then the process returns to step 286.

If, in step 286, it is determined that the voltage level of the power source does exceed the voltage supplied to the load by the power storage device, step 314 is entered where the power source supplies power to the load and the power storage device stops supplying power to the load. Following step 314, the process returns to step 266, where it is determined whether the supply voltage Vₛ is greater than the reference voltage V_{ref}.

The load can be substantially any load. For example, the load can be one or more chips on a board. The load can also be volatile or non-volatile memory such that during a power glitch data and processing is not lost. In one embodiment, the present apparatus and method additionally activate a procedure to store any data when the source voltage drops. In utilizing the store procedure, when the source voltage drops, the volatile and/or non-volatile memory is activated to store data while the power storage device 210 supplies power to the memory to initiate and typically complete the storing of data. Thus, stable power is supplied to the memory (and other loads) from an alternate power source that is positioned directly on the same board.

While the invention herein disclosed has been described by means of specific embodiments and applications thereof, numerous modifications and variations could be made thereto by those skilled in the art without departing from the scope of the invention.

What is claimed is:

1. An apparatus for providing ride-through power, comprising
a power storage device being configured to store power from a supply voltage without disrupting power supplied to a load, wherein the power storage device and the load are on a single circuit board; and
the power storage device being further configured to supply power to the load when the supply voltage drops.

2. as claimed in claim 1, wherein:
the power storage device is configured to supply power to the load when the supply voltage drops below a voltage across the power storage device.

3. as claimed in claim 2, wherein:
the power storage device having a first capacitor.

4. as claimed in claim 3, wherein:
the power storage device having a second capacitor coupled in series with the first capacitor.

5. as claimed in claim 1, further comprising:
a switch having a first state and a second state, wherein the switch is coupled with the power storage device such that the power storage device is capable of storing power when the switch is in the first state.

6. The apparatus as claimed in claim 5, further comprising:
a comparator having a first input being configured to receive the supply voltage, a second input being configured to receive a reference voltage, and a comparator output, wherein the comparator is configured to assert the comparator output when the supply voltage is at least equal to the reference voltage; and
the comparator output being coupled with the switch, wherein the switch is in the first state when the comparator output is asserted.

7. A circuit board, comprising:
a load configured to receive a supply voltage; and
an on-board ride-through compensator, comprising a power storage device being coupled with the load, and the power storage device being configured to store power from the supply voltage without disrupting power supplied to the load and to supply power to the load when the supply voltage drops.

8. The circuit board as claimed in claim 7, wherein:
the power storage device having a first capacitor.

9. The circuit board as claimed in claim 7, wherein:
the power storage device being configured to supply power to the load when the supply voltage drops below a voltage across the power storage device.

10. The circuit board as claimed in claim 7, further comprising:
a switch having a first state and a second state, wherein the switch is coupled with the power storage device such that the power storage device is capable of storing power when the switch is in the first state.

11. The circuit board as claimed in claim 10, further comprising:
a comparator having a first input being configured to receive the supply voltage, a second input being configured to receive a reference voltage, and an comparator output, wherein the comparator is configured to assert the comparator output when the supply voltage is at least equal to the reference voltage; and
the comparator output being coupled with the switch, wherein when the comparator output is asserted the switch is in the first state.

12. An apparatus for providing ride-through, comprising:
a comparator having a first input being configured to receive a first voltage, a second input being configured to receive a second voltage, and a comparator output, wherein the comparator asserts the comparator output when the first voltage is at least equal to the second voltage;
a switch coupled with the comparator output, wherein the switch is in a first state when the comparator output is asserted and in a second state when the comparator output is not asserted;
a power storage device being coupled with the switch, wherein the power storage device is configured to store power from the first voltage when the switch is in the first state; and
the power storage device being further configured to supply power if a drop in the first voltage occurs.

13. The apparatus as claimed in claim 12, wherein:
power storage device is configured to supply power if the first voltage drops below a voltage of the power storage device.

14. The apparatus as claimed in claim 12, wherein:
the power storage device couples with a load;
the power storage device being configured to store power from the first voltage without interfering with the operation of the load; and
the power storage device being configured to supply power to the load if the first voltage drops.

15. The apparatus as claimed in claim 14, wherein the power storage device includes a first capacitor coupled in series with a second capacitor.

16. The apparatus as claimed in claim 14, wherein the comparator, the power storage device and the load are configured on a signal circuit board.

17. A method for providing power compensation, comprising the steps of:
receiving a supply voltage;
determining if the supply voltage exceeds a reference voltage;
allowing operation of a load;
storing power from the supply voltage if the supply voltage exceeds the reference voltage without interfering with the operation of the load; and
supplying power to the load if the supply voltage drops.

18. The method as claimed in claim 17, wherein the step of allowing operation of a load includes allowing the operation of a load on a circuit board, and the step of supplying power includes supplying power from on the circuit board to the load if the supply voltage drops.

19. The method as claimed in claim 17, further comprising the step of asserting a switch to allow the step of storing power to initiate.

20. The method as claimed in claim 17, wherein the step of supplying power to the load if the supply voltage drops including preventing the load from experiencing the drop in voltage.

21. The method as claimed in claim 20, wherein the step of storing power includes charging up a power storage device from the supply voltage during the step of allowing operation of the load.

22. The method as claimed in claim 20, further comprising the steps of:
continuing to supply power to the load from the power storage device;
determining if the supply voltage exceeds a voltage supplied to the load in the step of continuing to supply power to the load; and
stopping the supply of power to the load from the power storage device if the supply voltage exceeds the voltage supplied by the power storage device.

23. A circuit board, comprising:
a load configured to receive a supply voltage; and
means for supplying power, comprising means for storing power coupled with the load, and the means for storing power stores power from the supply voltage without disrupting power supplied to the load and supplies power to the load when the supply voltage drops.

24. The circuit board as claimed in claim 23, further comprising:
means for switching having a first state and a second state, wherein the means for switching couples with the means for storing power such that the means for storing power stores power when the switch is in the first state.

25. The circuit board as claimed in claim 24, further comprising:
means for comparing having a first input being configured to receive the supply voltage, a second input being configured to receive a reference voltage, and an output, wherein the means for comparing asserts the output when the supply voltage is at least equal to the reference voltage; and
the output being coupled with the means for switching, wherein the means for switching is in the first state when the output is asserted.
